(19) United States
(12) Patent Application Publication
(10) Pub. No.: US 2026/0355798 A1
(43) Pub. Date: Nov. 12, 2026

(54) THERMAL WASTE RECYCLING VIA DETONATION SUPERHEATERS

(71) Applicant: Green Constellation Inc., Boynton Beach, FL (US)

(72) Inventors: Rafael Gazetov, Visaginas (LT); Arslan Saripov, Visaginas (LT); Marina Saripova, Visaginas (LT)

(21) Appl. No.: 19/641,690

(22) Filed: Apr. 8, 2026

Related U.S. Application Data
(60) Provisional application No. 63/786,501, filed on Apr. 10, 2025.

(51) Int. Cl. B09B 3/40; C01B 3/02

(52) U.S. Cl. CPC B09B 3/40; C01B 3/02

(57) ABSTRACT

A method and system are disclosed for thermal recycling of gaseous, liquid, and solid waste using counter supersonic jets of ultra-superheated steam generated by detonation steam superheaters. Steam is first superheated by continuously rotating detonation waves and then further superheated by multi-stage shock-resonant compression using longitudinally pulsating detonation waves reflected from cooled conical gas-dynamic resonators. The ultra-superheated steam jets and accompanying shock detonation waves are fed into a vortex reactor, where waste is thermally decomposed in a reducing atmosphere to form syngas, condensate of liquid acids, and solid residue. A portion of the syngas may be recycled for system operation. The product stream may be passed through a protective shield and into a centrifugal vortex-cooler separator, where hydrogen is withdrawn from a central region, carbon monoxide is withdrawn from a peripheral region, and condensate and solid residue are discharged.

### CROSS-REFERENCE TO RELATED APPLICATIONS

This nonprovisional application claims the benefit of U.S. Provisional Application No. 63/786,501 entitled “THERMAL WASTE RECYCLING VIA DETONATION SUPERHEATERS” filed Apr. 10, 2025, by the same inventors, all of which is incorporated herein by reference, in its entirety, for all purposes.

### BACKGROUND OF THE SUBJECT MATTER

### 1. Field of the Subject Matter

This subject matter relates, generally, to methods and an apparatus for thermal recycling of gaseous, liquid, and solid waste with ultra-superheated steam. More specifically, it relates to a method and apparatus of environmentally friendly thermal recycling of gaseous, liquid, and solid waste with ultra-superheated steam using detonation energy which can be used in space or on Earth to obtain synthesis gas.

### 2. Brief Description of the Prior Art

Deep thermochemical recycling of waste has been the subject of various engineering solutions aimed at producing useful outputs such as synthesis gas, acids, heat energy, and non-toxic solid residue. Conventional technologies for such conversion include high-temperature gasification techniques utilizing superheated air or steam as a gasifying agent. In the case of plasma gasification, highly superheated air is typically employed at temperatures ranging from 2000 °C to 3000 °C. Steam-based gasification methods rely on superheated steam in the range of 2200 °C to 2500 °C, and these processes are generally performed in a reducing atmosphere to inhibit the formation of harmful emissions.

These high-temperature systems are recognized for their ability to decompose organic and inorganic waste materials into elemental compounds such as hydrogen and carbon monoxide, while avoiding the production of toxic by-products like dioxins, furans, and nitrogen oxides. Furthermore, the absence of oxygen in the reaction chamber mitigates the formation of carbon dioxide and other greenhouse gases. However, both plasma and steam-based gasification methods incur substantial operational costs due to the energy demand required to generate and sustain the elevated thermal environments necessary for effective waste decomposition.

The primary limitations associated with existing high-temperature waste recycling systems involve the economic and technical feasibility of mass-producing highly superheated gasifying agents. The generation of air heated to 3000 °C or steam heated to 2500 °C demands high-capacity, energy-intensive infrastructure, which is costly to install, operate, and maintain. The long-term operational expense, coupled with significant capital investment requirements, have impeded the widespread adoption of these systems, particularly in applications where continuous, scalable waste treatment is required.

In response to these challenges, alternative approaches utilizing detonation energy for steam superheating have been investigated. Systems based on pulsed or continuous detonation combustion have demonstrated the capability to produce supersonic jets of superheated steam with relatively high thermal energy. These systems generally function by detonating stoichiometric mixtures of fuel and oxidizer, often diluted with low-temperature steam, to yield jets with temperatures exceeding 2200 K. However, such configurations are typically limited to steam temperatures around 2300 K and do not achieve the ultra-superheated regime exceeding 3000 °C, which is more effective for complete waste decomposition.

In some systems, pulsed detonation devices are integrated with gas-dynamic resonators to enhance the superheating of steam through shock compression. These devices allow the steam to be initially heated to a moderate level (e.g., 2000 °C) using pulsed detonation waves and subsequently further heated via reflected shock waves. While this multi-stage thermal elevation process increases the steam temperature to around 3500 °C and promotes dissociation into hydrogen and oxygen, such systems rely solely on pulsed detonation combustion. As a result, they are not optimized for continuous operation or for supporting high-throughput waste recycling systems.

The use of pulsed combustion in waste recycling reactors introduces several performance and durability issues. The reliance on pulsed jets and valve-based injection mechanisms results in cyclic mechanical and thermal stresses on reactor components. These stresses can lead to fatigue, premature failure of mechanical parts, and maintenance demands that undermine system longevity and throughput. Furthermore, pulsed operation tends to produce short-duration vortex structures within the reactor, which may limit the effective interaction time between the waste and the high-temperature environment, thereby reducing the quality of synthesis gas produced.

Other prior systems have explored the application of superheated steam jets in combination with vortex flow reactors. These systems often incorporate reactors that receive counter-pulsed jets of superheated steam to process particulate waste such as fly ash. The jets are accompanied by shock waves that prevent particle agglomeration and facilitate the dispersion of the waste throughout the reaction chamber. However, the vortex conditions generated in these devices are inherently non-stationary and diminish rapidly, limiting the duration and uniformity of waste exposure to the thermal treatment process. Consequently, synthesis gas produced in such configurations may retain unwanted residuals such as CH₄ and CO₂.

Additionally, reactor systems employing continuous detonation waves for waste processing have been proposed. These systems utilize opposed supersonic steam jets formed by continuously rotating detonation waves in a disk or annular combustion chamber. The counter steam jets are fed into a spherical reactor chamber in a coaxial and diametrically opposite direction, creating a stable vortex field that enhances fragmentation and thermal decomposition of waste particles. Such systems can reach steam temperatures on the order of 2127 °C (approximately 2400 K) and have been used to produce synthesis gas with minimal impurities. However, they do not incorporate mechanisms for further heating via shock-resonant compression by reflected longitudinal pulsated detonation waves, and thus they are not capable of generating steam temperatures exceeding 3000 °C.

While continuous-spin detonation-based steam superheaters improve upon pulsed systems in terms of stability and longevity, the absence of integrated cooled gas-dynamic resonators to exploit reflected longitudinal pulsated detonation waves limits the potential for further energy amplification. Without this secondary stage of shock-resonant compression, the temperature of the steam jets remains below the optimal threshold for complete decomposition of complex waste streams. Additionally, these systems do not facilitate the dissociation of steam into hydrogen and oxygen, which is advantageous for both energy recovery and closed-loop fuel integration. These limitations highlight the need for a system which integrates both continuous-spin detonation with multi-stage shock-resonant compression to generate ultra-superheated steam exceeding 3000 °C for effective, continuous, and scalable waste recycling.

Accordingly, what is needed is a method and device for deep thermal recycling of waste that utilizes counter supersonic jets of ultra-superheated steam produced through continuous rotating detonation and multi-stage shock-resonant compression to achieve sustained temperatures of 3000 °C and higher for complete waste decomposition and synthesis gas generation without impurities. However, in view of the art, considered as a whole at the time the present claimed subject matter was made, it was not obvious to those of ordinary skill in the field of this subject matter how the shortcomings of the prior art could be overcome.

### SUMMARY OF CLAIMED SUBJECT MATTER

The present claimed subject matter is directed to a method and device for the deep thermochemical recycling of gaseous, liquid, and solid waste using ultra-superheated steam produced by detonation energy. The claimed subject matter enables the formation of counter supersonic jets of ultra-superheated steam through a two-stage process that includes steam compression and superheating by rotating detonation waves and subsequent shock-resonant compression and superheating of steam by reflected longitudinally pulsating detonation waves. The purpose of the present claimed subject matter is to create an effective device for deep thermochemical recycling of gaseous, liquid, and solid waste without the formation of CH₄, CO₂, dioxins, furans, NOₓ and other greenhouse gases and harmful compounds.

In the first stage, the energy of rotating detonation waves is employed to preliminarily superheat steam to approximately 2000 °C. In the second stage, the energy of longitudinally pulsating detonation waves, repeatedly reflected from cooled conical gas-dynamic resonators, are utilized to further superheat the steam to temperatures reaching 3000 °C and higher.

Furthermore, the ultra-superheated steam jets are tangentially and counter-fed into a vortex reactor from detonation steam superheaters, establishing a stable vortex zone for waste decomposition. Detonation steam superheaters enable the continuous or batch feeding of waste materials and support their aerodynamic fragmentation, and the vortex reactor enables thermal decomposition of waste without combustion, in a reducing atmosphere. As a result of exposure to the high-temperature steam and shock detonation waves, the waste is converted into high-quality synthesis gas composed predominantly of hydrogen and carbon monoxide, with minimal or no content of CO₂, CH₄, dioxins, furans, NOₓ, or other harmful by-products. Additionally, the process yields useful outputs such as condensate of simplest liquid acids and a solid, non-toxic residue suitable for applications such as building materials.

Moreover, the system incorporates an integrated device architecture comprising a vortex reactor and detonation steam superheaters, each equipped with annular detonation chambers and coaxial gas-dynamic resonators. The device includes dedicated systems for the supply of fuel, oxidizer, and feedwater, as well as a protective shield and a common cooling system that circulates feedwater for thermal regulation. The configuration also enables autonomous operation by redirecting a portion of the produced synthesis gas back into the system as fuel for detonation, thereby reducing reliance on external energy sources. The heat-loaded walls of the detonation superheaters are cooled by internal flow of steam, feedwater jets, and a wall water film, which improves system durability and continuous operational capability.

Additionally, the subject matter features a centrifugal vortex cooler-separator downstream of the vortex reactor, which enables radial stratification and separation of the synthesis gas into individual components. Through this process, hydrogen is extracted from the central area of the flow while carbon monoxide is collected peripherally. Both gases are directed through dedicated outlet systems to be supplied to consumers, and a part of syngas is directed for reused within the system. The remaining condensate and solid non-toxic residue are also collected and discharged from a centrifugal vortex cooler-separator through separate outlets, allowing for complete waste material processing and resource recovery.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The claimed subject matter accordingly comprises the features of construction, combination of elements, and arrangement of parts that will be exemplified in the disclosure set forth hereinafter and the scope of the subject matter will be indicated in the claims.

### BRIEF DESCRIPTION OF THE DRAWINGS

For a fuller understanding of the claimed subject matter, reference should be made to the following detailed description, taken in connection with the accompanying drawings, in which:

FIG. 1A is a graphical illustration depicting a side view of an Advanced Waste Recycle and Management System (“AWRMS”) for liquid, gaseous, and solid waste by the thermal decomposition of waste using the energy of continuous-spin detonation waves, according to an embodiment of the present disclosure.

FIG. 1B is a graphical illustration depicting a top view of the AWRMS for liquid, gaseous, and solid waste by the thermal decomposition of waste using the energy of continuous-spin detonation waves, according to an embodiment of the present disclosure.

FIG. 2 is a graphical illustration depicting operation of an apparatus of a continuous-spin detonation steam superheater in the form of cooled continuous-spin detonation generator of superheated steam and hydrogen comprising an annular detonation chamber equipped with a coaxially placed cooled conical gas-dynamic resonator tangentially connected with a vortex reactor and equipped with a waste supply system, according to an embodiment of the present disclosure.

FIG. 3 is a graphical illustration depicting an isometric view of an AWRMS for liquid, gaseous, and solid waste by the thermal decomposition of waste using the energy of continuous-spin detonation waves, according to an embodiment of the present disclosure.

FIG. 4 is a graphical illustration depicting an Advanced Environmental Control and Life Support System (“AECLSS”) of an existing orbital space station using an AWRMS, according to an embodiment of the present disclosure.

### DETAILED DESCRIPTION OF THE CLAIMED SUBJECT MATTER

In the following detailed description of the preferred embodiments, reference is made to the accompanying drawings, which form a part thereof, and within which are shown by way of illustration specific embodiments by which the claimed subject matter may be practiced. It is to be understood that one skilled in the art will recognize that other embodiments may be utilized, and it will be apparent to one skilled in the art that structural changes may be made without departing from the scope of the subject matter.

As such, elements/components shown in diagrams are illustrative of exemplary embodiments of the disclosure and are meant to avoid obscuring the disclosure. Any headings used herein are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

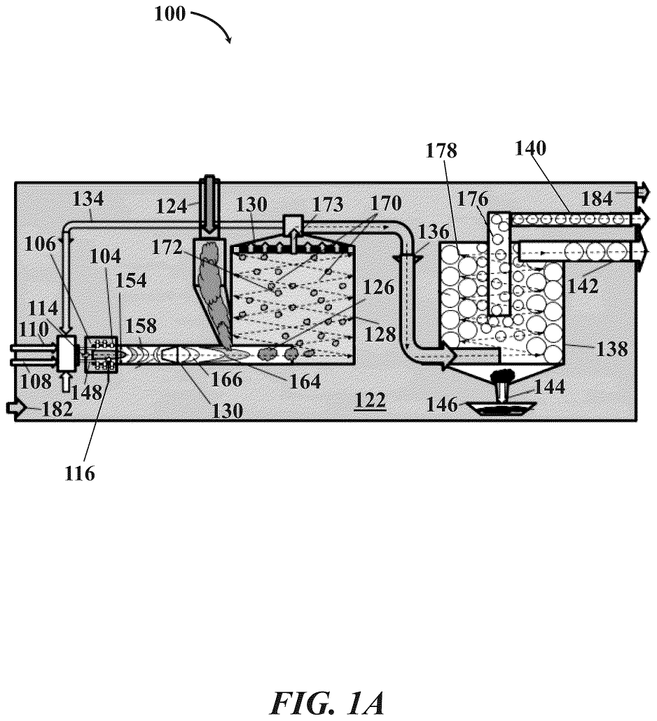

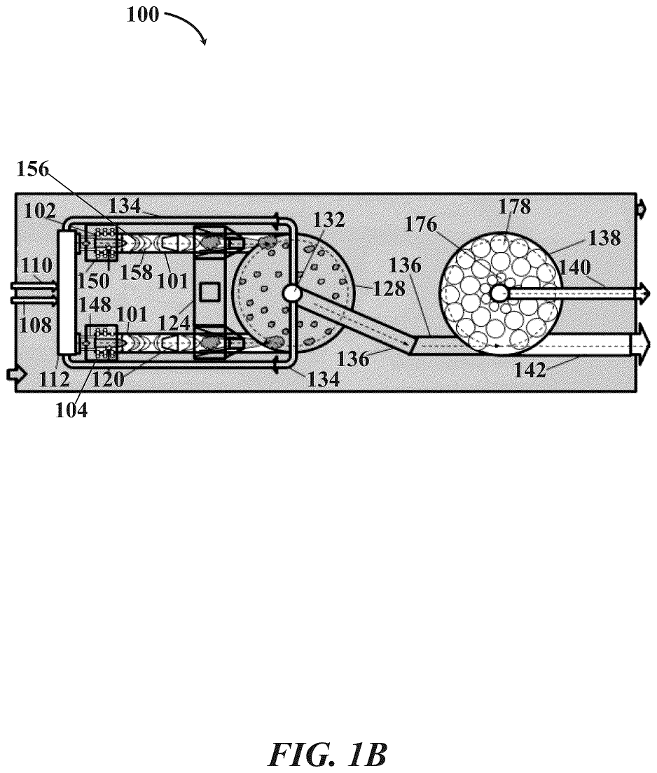

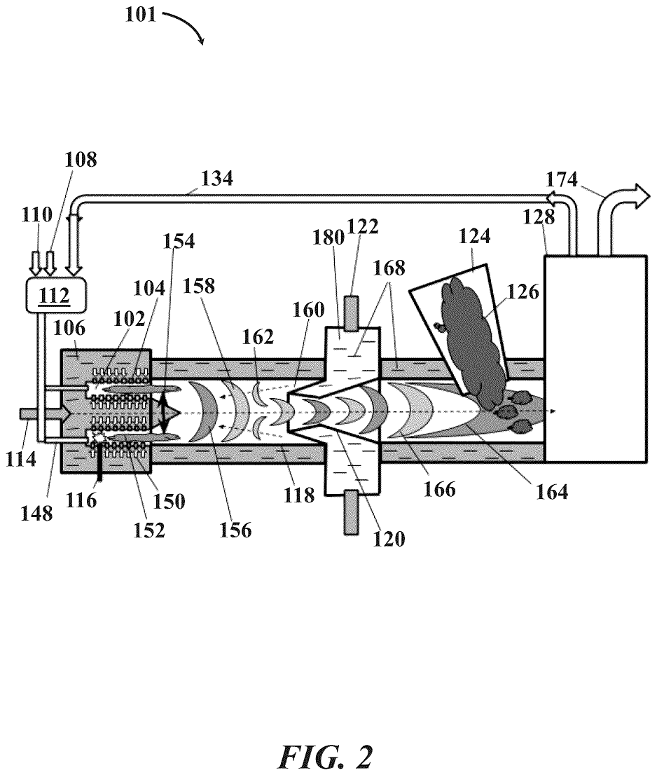

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present claimed subject matter defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compacts disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

As used herein, the term “communicatively coupled” refers to any coupling mechanism known in the art, such that at least one electrical signal may be transmitted between one device and one alternative device. Communicatively coupled may refer to Wi-Fi, Bluetooth, wired connections, wireless connection, and/or magnets. For ease of reference, the exemplary embodiment described herein refers to Wi-Fi and/or Bluetooth, but this description should not be interpreted as exclusionary of other electrical coupling mechanisms.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system) (e.g., the degree of precision required for a particular purpose). As used herein, “about,” “approximately,” or “roughly” refer to within ±25% of the numerical value.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about.” It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Advanced Waste Recycle and Management System

The present disclosure pertains to an Advanced Waste Recycle and Management System (“AWRMS”) 100 configured to thermally recycle gaseous, liquid, and/or solid waste by using the energy of one or more continuous-spin detonation waves to generate one or more supersonic jets of ultra superheated steam 164. In some embodiments, AWRMS 100 is arranged to convert waste 126 into a gaseous product stream including hydrogen and carbon monoxide, a condensate stream, and a solid residue stream.

As shown in FIGS. 1A-1B, in some embodiments, AWRMS 100 includes one or more detonation steam superheaters 101 operably associated with a vortex reactor 128 to thermally process waste. Moreover, in some embodiments, a protective shield 130 is positioned downstream of vortex reactor 128. Additionally, AWRMS 100 may include a syngas outlet system 132 configured to withdraw process gas generated by vortex reactor 128. In this manner, at least a portion of the withdrawn syngas may be directed through syngas recycle system 134 for internal use and through syngas supply system 136 for delivery to a downstream consumer.

In some embodiments, the withdrawn gas is further routed to centrifugal vortex-cooler separator 138 which is operably coupled to a hydrogen outlet system 140, a monoxide outlet system 142, and/or a slag and condensate outlet system 144 to separate gaseous and non-gaseous process products. Furthermore, a storage vessel 146 may be configured to receive material discharged from slag and condensate outlet system 144. Additionally, a cooling system 122 may be provided to remove heat from one or more portions of AWRMS 100 during operation.

As shown in FIGS. 1A-1B, in some implementations, AWRMS 100 includes one or more detonation steam superheaters 101 positioned to deliver counter streams toward vortex reactor 128. In some embodiments, a first detonation steam superheater 101 and a second detonation steam superheater 101 can be fluidly coupled to vortex reactor 128. In some embodiments, the first and second detonation steam superheaters 101 are arranged on opposite sides of vortex reactor 128 and are configured such that the one or more supersonic jets of ultra superheated steam 164 enter vortex reactor 128 tangentially and in counter relation to one another.

Moreover, in some embodiments, the first detonation steam superheater 101 produces a first supersonic superheated steam jet and a first supersonic ultra-superheated steam jet while the second detonation steam superheater 101 produces a second supersonic superheated steam jet and a second supersonic ultra-superheated steam jet.

Although FIG. 1B depicts two detonation steam superheaters 101, the disclosed subject matter is not limited to two superheaters. In some embodiments, AWRMS 100 includes a single detonation steam superheater 101. In some other embodiments, AWRMS 100 includes three or more detonation steam superheaters 101 arranged symmetrically or asymmetrically about vortex reactor 128. In still further embodiments, one or more superheaters 101 may be operated continuously while one or more additional superheaters 101 are selectively activated, deactivated, throttled, and/or reserved for startup, maintenance, and/or load-following operation.

As depicted in FIG. 2, each detonation steam superheater 101 includes an annular detonation chamber 102 configured to receive reactants and support detonation-based steam superheating. In some embodiments, first inner annular cavity 106 is disposed adjacent annular detonation chamber 102 and is fluidly coupled to feed water supply system 114 such that feedwater may be introduced, heated, and/or discharged through one or more hole turbulators 104 into annular detonation chamber 102.

Moreover, in some embodiments, a fuel supply system 108 and an oxidizer supply system 110 may be configured to deliver reactants to a receiver 112 arranged upstream of annular detonation chamber 102. Additionally, an ignition system 116 is positioned to initiate detonation within annular detonation chamber 102 which extends downstream therefrom toward gas-dynamic resonator 120. A cooling system 122 may be configured to circulate cooling fluid through one or more portions of detonation steam superheater 101.

In some embodiments, detonation steam superheater 101 further includes second inner annular cavity 180. In some embodiments, one or more injectors are fluidly coupled between receiver 112 and annular detonation chamber 102 to introduce one or more reactant mixtures into annular detonation chamber 102, and such injectors may include one or more binary stoichiometric mixture jet injectors, one or more triple stoichiometric mixture jet injectors, or both.

In some embodiments, annular detonation chamber 102 is a generally toroidal and/or annular combustion volume configured to support continuous-spin detonation of a stoichiometric mixture. Accordingly, annular detonation chamber 102 may be defined between coaxial inner and outer walls and/or may have a circular, oval, polygonal, or multi-lobed cross-section. In some embodiments, annular detonation chamber 102 is formed from heat-resistant metallic materials, ceramic materials, refractory materials, cermet materials, composite materials, and/or combinations thereof.

Moreover, one or more hole turbulators 104 may be disposed in or through a wall associated with annular detonation chamber 102 and configured to introduce feed water, steam, or both into annular detonation chamber 102. In some embodiments, the one or more hole turbulators 104 are formed as distributed perforations, nozzles, slots, porous inserts, and/or microchannel outlets. In some embodiments, hole turbulators 104 are arranged circumferentially, helically, axially, radially, and/or in another distribution selected to promote turbulence, mixing, wall wetting, heat transfer, and/or combinations thereof.

Additionally, a first inner annular cavity 106 and a second inner annular cavity 180 may be configured as feed passages, cooling passages, plenums, manifolds, and/or combinations thereof. In some embodiments, first inner annular cavity 106 and/or second inner annular cavity 180 are positioned adjacent respective portions of annular detonation chamber 102 and contain moving feed water, steam, and/or coolant so that heat is transferred from annular detonation chamber 102 into the fluid located in the cavities. In some embodiments, one cavity is used predominantly for fluid delivery while the other cavity is used predominantly for heat removal or return flow. In some other embodiments, the cavities are both used for delivery and cooling.

In some embodiments, fuel supply system 108 is configured to deliver fuel to receiver 112, directly to annular detonation chamber 102, or to both. In some embodiments, the fuel includes hydrogen. Moreover, in some other embodiments, the fuel includes recycled syngas, a hydrogen-rich fraction, carbon monoxide-containing gas, methane, natural gas, propane, another combustible gas, vaporized liquid fuel, and/or a combination thereof. Additionally, at least a portion of the fuel may be provided from recycled process gas or from a downstream hydrogen stream and/or a startup or supplemental fuel may be provided from a stored fuel source or an external distribution line.

In some implementations, oxidizer supply system 110 is configured to deliver an oxidizer to receiver 112, directly to annular detonation chamber 102, or to both. In some embodiments, the oxidizer is oxygen. In some other embodiments, the oxidizer is oxygen-enriched air, air, and/or another oxygen-containing gas mixture capable of supporting detonation in the intended operating regime. Furthermore, the relative rates of fuel and oxidizer delivered through fuel supply system 108 and oxidizer supply system 110 may be controlled so that the mixture entering annular detonation chamber 102 is stoichiometric, near stoichiometric, fuel rich, oxidizer lean, and/or otherwise adjusted to achieve a selected detonation condition.

Moreover, receiver 112 may be a mixing chamber, plenum, header, manifold, cavity, and/or another intermediate volume configured to receive fuel and oxidizer prior to delivery into annular detonation chamber 102. In some embodiments, receiver 112 is configured to form a binary stoichiometric mixture 148 during startup. In some embodiments, receiver 112 also receives recycled syngas through syngas recycle system 134, or receives separated hydrogen, or both.

Feed water supply system 114 is configured to deliver feed water into first inner annular cavity 106, second inner annular cavity 180, one or both superheaters 101, and/or a combination thereof. In some embodiments, the feed water enters the superheater through an inlet of feed water 182 and exits through an outlet of feed water 184 after absorbing heat. In some other embodiments, the feed water is converted in whole or in part into one or more steam jets 150 as it is discharged through one or more hole turbulators 104 into annular detonation chamber 102.

As shown in FIG. 2, in some embodiments, ignition system 116 is configured to initiate detonation of one or more mixtures supplied to annular detonation chamber 102. In some embodiments, ignition system 116 includes one or more spark plugs, plasma igniters, laser igniters, hot-surface igniters, catalytic igniters, pilot igniters, and/or a combination thereof. In some embodiments, ignition system 116 is used during startup and is deactivated and/or used intermittently after detonation becomes self-sustaining. In some embodiments, ignition system 116 is positioned to ignite a stoichiometric mixture delivered through the one or more injectors to annular detonation chamber 102.

In some embodiments, startup of detonation steam superheater 101 begins by supplying fuel through fuel supply system 108 and oxidizer through oxidizer supply system 110 into receiver 112. In this manner, receiver 112 forms a binary stoichiometric mixture 148 comprising hydrogen and oxygen which is introduced into annular detonation chamber 102 through one or more injectors. Moreover, an ignition system 116 then initiates combustion and detonation in annular detonation chamber 102.

In some embodiments, In some embodiments, once feedwater supply system 114 is activated, feedwater is introduced into first inner annular cavity 106 and/or second inner annular cavity 180 which is heated by heat transferred from annular detonation chamber 102 and surrounding walls. Accordingly, the heated feed water then passes through one or more hole turbulators 104 and forms one or more steam jets 150 in annular detonation chamber 102.

Referring to FIGS. 1A-1B, in conjunction with FIG. 2, one or more steam jets 150 combine with fuel and oxidizer to form a triple stoichiometric mixture 152. In some embodiments, the relative amounts of fuel, oxidizer, and steam in triple stoichiometric mixture 152 are selected to promote stable continuous-spin detonation while also producing a steam-rich working flow. In some embodiments, triple stoichiometric mixture 152 includes hydrogen, oxygen, and/or steam and is delivered into annular detonation chamber 102 through one or more of the injectors.

During operation, one or more rotating detonation waves 154 circulate within annular detonation chamber 102. In some embodiments, one or more rotating detonation waves 154 continuously travel around the annular extent of annular detonation chamber 102 and compress and/or heat triple stoichiometric mixture 152. This first stage of heating may produce a supersonic superheated steam jet 156 at the outlet of annular detonation chamber 102 and/or in the upstream portion of detonation channel 118.

In some embodiments, the first-stage heating raises the temperature of the steam ranging from about 1500 °C to about 2000 °C. Additionally, the actual temperature may vary with chamber geometry, pressure, feed composition, wave speed, oxidizer purity, fuel type, coolant state, and other operating parameters.

Referring again to FIGS. 1A-1B, in conjunction with FIG. 2, detonation channel 118 extends downstream of annular detonation chamber 102 and is configured to direct the first-stage flow toward gas-dynamic resonator 120. In some embodiments, detonation channel 118 is substantially straight and coaxial with annular detonation chamber 102 and gas-dynamic resonator 120. In some other embodiments, detonation channel 118 may be curved, tapered, stepped, segmented, and/or otherwise shaped to guide wave propagation, influence residence time, alter local pressure, and/or accommodate packaging constraints.

Furthermore, in some implementations, a gas-dynamic resonator 120 is arranged downstream of annular detonation chamber 102 and in operable communication with detonation channel 118. In some embodiments, gas-dynamic resonator 120 may be formed as a venturi, a stepped nozzle, a multi-cone resonator, an annular resonator, a variable-geometry resonator, and/or another structure configured to reflect, shape, and interact with detonation-driven pressure waves.

As shown in FIG. 2, gas-dynamic resonator 120 may define outer annular conical cavity 160. In some embodiments, one or more longitudinally pulsating waves 158 propagate from annular detonation chamber 102 through detonation channel 118 into outer annular conical cavity 160. Moreover, one or more reflected detonation waves 162 are then produced by interaction of the longitudinally pulsating waves 158 with the geometry of gas-dynamic resonator 120.

In some embodiments, one or more reflected detonation waves 162 repeatedly interact with incoming one or more longitudinally pulsating waves 158, which produces a multi-stage shock-resonant compression of the steam-containing flow. Accordingly, this second stage of heating transforms supersonic superheated steam jet 156 into one or more supersonic jets of ultra superheated steam 164.

In some embodiments having the first and second detonation steam superheaters 101, longitudinally pulsating waves propagate into a respective cooled conical gas-dynamic resonator 120 and are repeatedly reflected from the respective cooled conical gas-dynamic resonator 120 to subject the first supersonic superheated steam jet and the second supersonic superheated steam jet to multi-stage shock-resonant compression and thereby produce the first supersonic ultra-superheated steam jet and the second supersonic ultra-superheated steam jet. In some embodiments, one or more resulting shock detonation waves 166 accompany one or more supersonic jets of ultra superheated steam 164 downstream of gas-dynamic resonator 120.

Additionally, the second-stage heating may raise the temperature of the steam to at least about 2500 °C. In some embodiments, selected local portions of the flow may exceed these values. In some other embodiments, the second-stage heating may additionally promote partial thermal dissociation of steam or one or more other reactive species present in the working flow.

In some implementations, gas-dynamic resonator 120 may be actively cooled by cooling system 122. In this manner, cooling system 122 may circulate feed cooling water 168 through a local cooling container, jacket, cavity, passage, annular chamber, and/or heat exchange region associated with gas-dynamic resonator 120. In some embodiments, feed cooling water 168 extracted from gas-dynamic resonator 120 is returned to feed water supply system 114, to first inner annular cavity 106, to second inner annular cavity 180, and/or to another portion of the thermal management circuit.

Cooling system 122 may be local to each detonation steam superheater 101 or common to AWRMS 100. In some embodiments, cooling system 122 removes heat from detonation steam superheaters 101, vortex reactor 128, centrifugal vortex-cooler separator 138, or combinations thereof. In some embodiments, cooling system 122 is a closed-loop water circuit. In other embodiments, cooling system 122 may circulate condensate, deionized water, treated wastewater, another heat transfer fluid, or combinations thereof.

Waste supply system 124 is configured to introduce waste 126 into the flow path of detonation steam superheater 101, directly into vortex reactor 128, or into both. In some embodiments, waste 126 is introduced into detonation channel 118 downstream of annular detonation chamber 102 and upstream of vortex reactor 128 so that waste 126 is entrained by one or more supersonic jets of ultra superheated steam 164 before entering vortex reactor 128.

Moreover, waste 126 may include liquid waste, gaseous waste, solid waste, or combinations thereof. Accordingly, waste 126 may be an aqueous suspension comprising liquid waste, gaseous waste, and fragmented solid waste. In some other embodiments, waste 126 may include wastewater, urine, condensate, biomass, food waste, plastic waste, polymer waste, medical waste, packaging waste, industrial sludge, sewage-derived solids, carbon-containing residue, hydrocarbon gases, methane, carbon dioxide-containing streams, or combinations thereof.

Furthermore, waste supply system 124 may include one or more pumps, atomizers, nozzles, valves, lock hoppers, augers, screw feeders, slurry injectors, venturi entrainment devices, gas injectors, and/or a combination thereof. In some implementations, separate waste supply systems 124 are provided for liquid, gaseous, and solid waste. In this manner, the respective streams may be combined upstream of detonation channel 118 or within vortex reactor 128.

Referring again to FIGS. 1A-1B, in conjunction with FIG. 2, in some embodiments, vortex reactor 128 is configured to receive one or more supersonic jets of ultra superheated steam 164 and/or one or more resulting shock detonation waves 166. Accordingly, vortex reactor 128 receives counter streams from opposing detonation steam superheaters 101 through tangential inlets that establish a rotating flow field within vortex reactor 128.

Accordingly, counter interaction of the incoming streams in vortex reactor 128 produces counter vortex flows 170 that suspend and fragment waste particles 172. In some embodiments, waste particles 172 remain within a rotating high-temperature region for a residence time sufficient to effect thermal decomposition, cracking, reforming, drying, devolatilization, gasification, or combinations thereof.

Additionally, vortex reactor 128 may be cylindrical, spherical, spheroidal, ellipsoidal, frustoconical, toroidal, polygonal, or another enclosed chamber shape configured to maintain a rotating internal flow. Furthermore, internal surfaces of vortex reactor 128 may be refractory lined, metallic and cooled, or provided with replaceable liners or sacrificial shields in selected high-load regions. During operation, vortex reactor 128 may be maintained so that oxygen available in the waste-treatment region is reduced relative to conventional incineration systems. As such, the system may promote decomposition and gasification reactions rather than open-flame combustion.

As shown in FIG. 1A, in some embodiments, syngas jet 173 exits vortex reactor 128. As shown in FIG. 2, the discharged gas stream may be a supersonic syngas jet 174. Moreover, the gaseous product may comprise hydrogen, carbon monoxide, steam, entrained condensable species, and trace constituents, with composition varying based on waste composition, reactor temperature, steam-to-carbon ratio, oxygen availability, residence time, and/or recycle rate.

In some implementations, protective shield 130 is disposed downstream of vortex reactor 128 and is configured to intercept, deflect, or retain solid matter while allowing gaseous products to pass toward downstream gas handling components. For example, protective shield 130 may be a baffle, plate, cone, mesh, perforated barrier, louver, labyrinth member, inertial separator, or combination thereof. Furthermore, protective shield 130 may be cooled or lined with a high-temperature-resistant material.

Additionally, in some embodiments, syngas outlet system 132 is in communication with vortex reactor 128 and is configured to withdraw gaseous products from vortex reactor 128. In some embodiments, syngas outlet system 132 directs the gaseous products toward centrifugal vortex-cooler separator 138. In some implementations, syngas outlet system 132 may be insulated, cooled, pressure controlled, or equipped with one or more valves or throttling devices.

Moreover, in some embodiments, syngas recycle system 134 is configured to direct at least a portion of the process gas back to detonation steam superheater 101, receiver 112, fuel supply system 108, and/or a combination thereof. In some embodiments, syngas recycle system 134 operates during steady-state operation after startup fuel is reduced or discontinued. In some other embodiments, syngas recycle system 134 includes one or more compressors, blowers, regulators, pumps, filters, condensate traps, valves, and/or storage volumes.

Furthermore, in some embodiments, syngas supply system 136 is configured to deliver gaseous product to a downstream consumer. In this manner, depending on the application, syngas supply system 136 may deliver mixed syngas, a hydrogen-rich stream, a carbon-monoxide-rich stream, or combinations thereof. Accordingly, the downstream consumer may be a fuel cell, Sabatier reactor, chemical synthesis unit, combustor, thermal device, energy storage system, or another utilization unit.

In some embodiments, centrifugal vortex-cooler separator 138 is configured to receive gaseous product from syngas outlet system 132, syngas supply system 136, or both. In some implementations, centrifugal vortex-cooler separator 138 receives the gas tangentially so that the gas expands, cools, and rotates within the separator.

Within centrifugal vortex-cooler separator 138, a centrifugal field may promote radial stratification of the rotating gas. Accordingly, hydrogen molecules 176 may be concentrated toward a central region of centrifugal vortex-cooler separator 138 and withdrawn through hydrogen outlet system 140, while carbon monoxide molecules 178 may be concentrated toward a peripheral region and withdrawn through monoxide outlet system 142. In this manner, the separation may produce enriched, rather than pure, product streams. Additionally, downstream purification, compression, storage, or conditioning equipment may be provided as needed.

In some implementations, a slag and condensate outlet system 144 is configured to remove liquid condensate and solid residue from centrifugal vortex-cooler separator 138. In some embodiments, the condensate may include water and one or more acids or acid precursors, and the solid residue may include mineral matter, oxides, salts, vitrified matter, carbonaceous residue, metal-containing matter, and/or a combination thereof.

Additionally, storage vessel 146 is configured to receive material discharged from slag and condensate outlet system 144 and may be a removable vessel, cartridge, canister, hopper, tank, and/or other collection container. In some other embodiments, separate vessels may be provided for liquid and solid streams, and one or more sensors may be associated with storage vessel 146 to indicate fill level, temperature, pH, conductivity, pressure, and/or composition.

In some implementations, AWRMS 100 includes a control system configured to monitor and regulate operation of the illustrated components. In some embodiments, the control system receives data from one or more temperature sensors, pressure sensors, flow sensors, composition sensors, optical sensors, acoustic sensors, vibration sensors, and/or a combination thereof located at annular detonation chamber 102, gas-dynamic resonator 120, vortex reactor 128, centrifugal vortex-cooler separator 138, and/or along the associated conduits.

As such, the control system operates the system in a startup mode in which startup gas or hydrogen and startup oxygen are supplied to receiver 112 of each detonation steam superheater 101, and in a steady-state mode in which a portion of syngas is supplied for internal use. Additionally, the control system may adjust fuel flow, oxidizer flow, feed water flow, recycle rate, waste feed rate, ignition timing, chamber pressure, separator pressure, outlet flow, and/or coolant circulation. The control system may also start, stop, and/or modulate individual detonation steam superheaters 101 independently.

Additionally, materials of construction used for detonation steam superheater 101, vortex reactor 128, protective shield 130, centrifugal vortex-cooler separator 138, and associated flow paths may include nickel-based alloys, stainless steels, cobalt alloys, refractory metals, ceramics, cermets, oxide ceramics, silicon carbide, carbon-based composites, protective coatings, thermal barrier coatings, and/or a combination thereof. Furthermore, selected surfaces exposed to repeated wave impact or severe heat flux may be provided with replaceable liners, erosion-resistant coatings, oxidation-resistant coatings, sacrificial inserts, and/or internal cooling features.

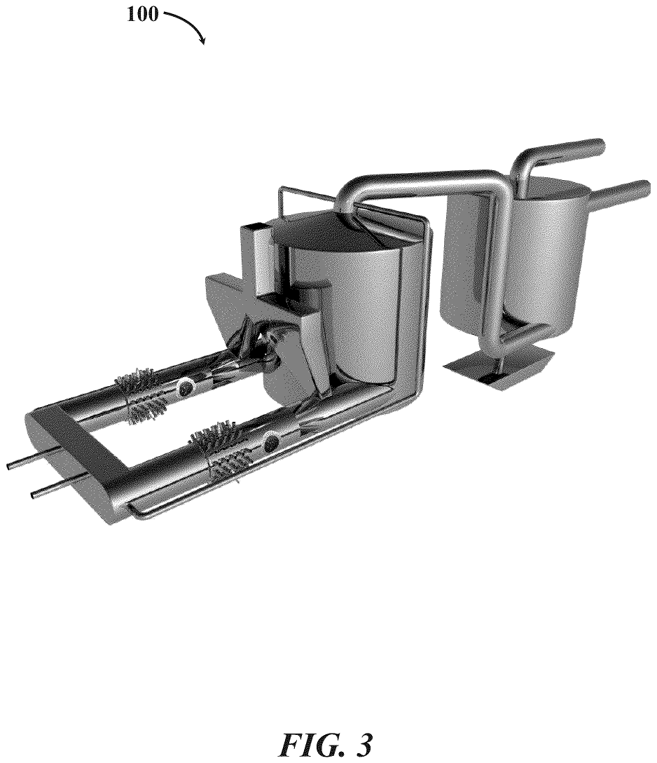

FIG. 3 depicts an isometric view of AWRMS 100 and illustrates that the disclosed system may be fabricated as a compact module. For example, AWRMS 100 may be skid mounted, frame mounted, containerized, rack mounted, and/or integrated into a larger process plant. Additionally, detonation steam superheaters 101 may be assembled as removable cartridges to facilitate inspection, replacement, or maintenance.

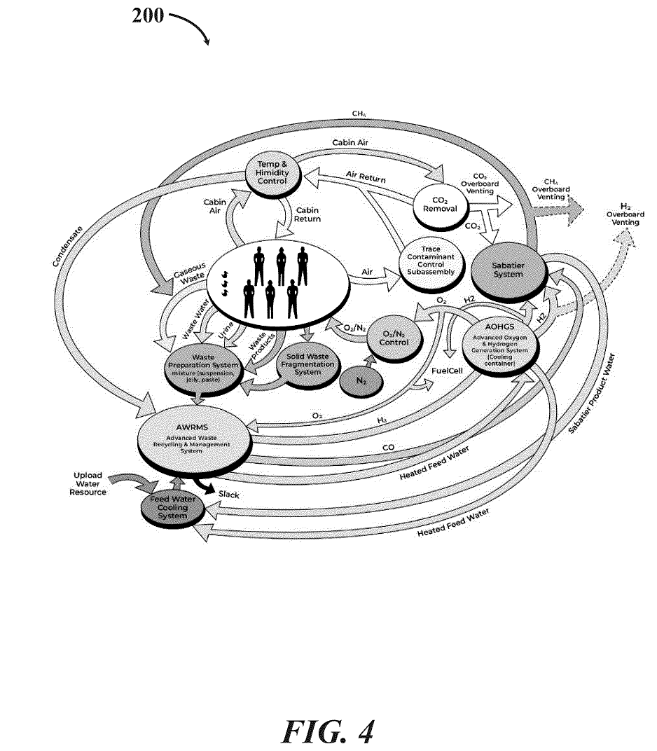

FIG. 4 depicts an Advanced Environmental Control and Life Support System (“AECLSS”) 200 including AWRMS 100. In this manner, in some embodiments, AWRMS 100 is integrated with one or more waste preparation units, waste fragmentation units, cabin air processing units, gas utilization units, fuel cells, oxygen-handling units, carbon-dioxide-handling units, thermal recovery units, and/or water recovery units. Accordingly, AWRMS 100 may receive solid, liquid, and gaseous waste generated by personnel in a closed habitat and return one or more useful products including thermal energy, heated feed water, hydrogen, carbon monoxide, and reduced-volume residue.

In some embodiments, waste 126 supplied to waste supply system 124 is prepared upstream by crushing, shredding, granulating, drying, slurry formation, homogenization, filtration, or combinations thereof. Additionally, fragmented solids may be mixed with liquids and gaseous waste to form an aqueous suspension. In other embodiments, waste streams may be metered separately and combined after entering the process.

Moreover, the disclosed system may be operated continuously, semi-continuously, or batchwise. As such, waste 126 may be fed continuously, in portions, or in pulses, while gaseous product may be removed continuously and condensate and solids may be removed continuously or periodically.

Additionally, operating parameters may be selected so that the local instantaneous temperature in portions of vortex reactor 128 approaches or exceeds about 3000 °C while the average temperature of process products within vortex reactor 128 is at least about 2000 °C. In other embodiments, lower or higher temperatures may be used depending on waste conversion chemistry, product composition, wall loading, component life, and throughput.

In some other embodiments, gas-dynamic resonator 120 may be fixed in geometry. In other embodiments, gas-dynamic resonator 120 includes adjustable inserts, movable cones, movable throats, replaceable liners, or segmented walls to change resonant volume, throat area, divergence angle, or reflection characteristics during operation or between operating campaigns.

In some implementations, one or more hole turbulators 104 may have uniform size and spacing. In other embodiments, one or more hole turbulators 104 have varying sizes, varying spacing, or staged groups to control local steam injection distribution along annular detonation chamber 102. Additionally, separate groups of hole turbulators 104 may be selectively supplied or isolated to tailor chamber cooling and mixture formation.

In some other embodiments, detonation channel 118 may be a single annular or tubular passage. In other embodiments, detonation channel 118 comprises multiple channels, segmented passages, guide vanes, mixing elements, or internal liners. Furthermore, waste 126 may be introduced through one or more side ports into detonation channel 118 so that entrainment occurs before waste 126 reaches vortex reactor 128. In some implementations, centrifugal vortex-cooler separator 138 is the primary gas-separation unit. In other embodiments, centrifugal vortex-cooler separator 138 is followed by or preceded by one or more cyclones, condensers, quench units, filters, membranes, sorbent beds, catalytic units, electrostatic devices, pressure-swing systems, or cryogenic devices to further condition and/or separate the process streams.

Moreover, hydrogen outlet system 140 may provide hydrogen to a Sabatier unit, a fuel cell, a storage tank, a propulsion-related subsystem, or another hydrogen consumer. Additionally, monoxide outlet system 142 may provide a carbon-monoxide-containing stream to a chemical synthesis unit, a reduction process, a fuel conversion device, or another downstream consumer. In some implementations, one or both outlet streams may be recombined, partially recycled, or blended with other gases.

In some implementations, one or more components of AWRMS 100 are integrated into a common housing. In other embodiments, one or more components are spaced apart and connected by conduits, manifolds, or transfer lines. Additionally, at least one component may be mounted on vibration isolators, thermal isolators, or service rails to facilitate operation and maintenance. Furthermore, one or more portions of the process may be operated at above-atmospheric pressure, near-atmospheric pressure, or reduced pressure. Accordingly, pressure control may be selected to affect detonation stability, steam density, residence time, product distribution, or sealing requirements.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the claimed subject matter herein described, and all statements of the scope of the subject matter which, as a matter of language, might be said to fall therebetween.

What is claimed is:

1. A method for thermal recycling of waste, the method comprising:
a. supplying a fuel, an oxidizer, and feedwater to a first detonation steam superheater and a second detonation steam superheater;
b. generating, in each of the first detonation steam superheater and the second detonation steam superheater, rotating detonation waves in a stoichiometric mixture comprising the fuel, the oxidizer, and steam to produce a respective supersonic superheated steam jet;
c. propagating longitudinally pulsating detonation waves from each of the first detonation steam superheater and the second detonation steam superheater into a respective cooled conical gas-dynamic resonator and repeatedly reflecting the longitudinally pulsating detonation waves from the respective cooled conical gas-dynamic resonator to subject the respective supersonic superheated steam jet to multi-stage shock-resonant compression and thereby produce a respective supersonic ultra-superheated steam jet;
d. feeding the respective supersonic ultra-superheated steam jets tangentially into a vortex reactor in opposing directions;
e. feeding the waste to the vortex reactor;
f. maintaining a reducing atmosphere in the vortex reactor;
g. thermally decomposing the waste in the vortex reactor under combined action of the respective supersonic ultra-superheated steam jets and shock detonation waves accompanying the respective supersonic ultra-superheated steam jets to form a product stream comprising syngas, condensate of liquid acids, and solid residue; and
h. removing at least a portion of the product stream from the vortex reactor.

2. The method of claim 1, wherein, during startup of each of the first detonation steam superheater and the second detonation steam superheater, hydrogen and oxygen are mixed to form a binary stoichiometric mixture that is ignited, and wherein, after steam generation begins, hydrogen, oxygen, and steam are combined to form a triple stoichiometric mixture.

3. The method of claim 1, wherein supplying the feedwater comprises feeding the feedwater into an inner annular cavity of each of the first detonation steam superheater and the second detonation steam superheater and injecting heated feedwater from the inner annular cavity through hole-turbulators into a respective annular detonation chamber to form primary steam jets.

4. The method of claim 1, wherein the rotating detonation waves superheat steam to about 2000 °C before the multi-stage shock-resonant compression, and wherein the multi-stage shock-resonant compression superheats the steam to about 3000 °C or higher.

5. The method of claim 1, wherein feeding the waste comprises introducing the waste into at least one detonation channel upstream of the vortex reactor so that the waste is entrained by at least one of the respective supersonic ultra-superheated steam jets before entering the vortex reactor.

6. The method of claim 1, wherein the waste comprises an aqueous suspension including liquid waste, gaseous waste, and fragmented solid waste.

7. The method of claim 1, further comprising diverting a portion of the syngas to a receiver and using the portion of the syngas as fuel for at least one of the first detonation steam superheater or the second detonation steam superheater.

8. The method of claim 1, further comprising passing a gaseous portion of the product stream through a protective shield that retains solid particles and tangentially feeding the gaseous portion into a centrifugal vortex-cooler separator, radially stratifying the gaseous portion in the centrifugal vortex-cooler separator, withdrawing hydrogen from a central region of the centrifugal vortex-cooler separator, withdrawing carbon monoxide from a peripheral region of the centrifugal vortex-cooler separator, and discharging the condensate of liquid acids and the solid residue through a slag and condensate outlet system.

9. A system for thermal recycling of waste, the system comprising:
a. a vortex reactor;
b. a first detonation steam superheater fluidly coupled to the vortex reactor;
c. a second detonation steam superheater fluidly coupled to the vortex
reactor; and
d. a waste supply system configured to deliver waste to the vortex reactor or to at least one of the first detonation steam superheater or the second detonation steam superheater;
e. wherein each of the first detonation steam superheater and the second detonation steam superheater comprises a detonation chamber, a feedwater supply system, a detonation channel, and a gas-dynamic resonator in communication with the detonation channel,
f. wherein the detonation chamber is configured to support rotating detonation waves that generate a supersonic superheated steam jet; and
g. wherein the gas-dynamic resonator is configured to receive longitudinally pulsating detonation waves from the detonation channel and to subject the supersonic superheated steam jet to shock-resonant compression to produce a supersonic ultra-superheated steam jet.

10. The system of claim 9, wherein the first detonation steam superheater and the second detonation steam superheater are arranged to feed respective supersonic ultra-superheated steam jets tangentially into the vortex reactor in opposing directions.

11. The system of claim 9, wherein each of the first detonation steam superheater and the second detonation steam superheater further comprises an annular detonation chamber, a receiver, a fuel supply system fluidly coupled to the receiver, an oxidizer supply system fluidly coupled to the receiver, one or more injectors fluidly coupled between the receiver and the annular detonation chamber, and an ignition system positioned to ignite a mixture delivered through the one or more injectors to the annular detonation chamber.

12. The system of claim 11, wherein each of the first detonation steam superheater and the second detonation steam superheater further comprises an inner annular cavity and a plurality of hole-turbulators disposed in a wall of the annular detonation chamber and configured to inject heated feedwater from the inner annular cavity into the annular detonation chamber.

13. The system of claim 9, wherein, in each of the first detonation steam superheater and the second detonation steam superheater, the gas-dynamic resonator is a cooled conical gas-dynamic resonator configured to repeatedly reflect the longitudinally pulsating detonation waves.

14. The system of claim 9, further comprising a protective shield positioned downstream of the vortex reactor and a syngas outlet system coupled to the vortex reactor downstream of the protective shield.

15. The system of claim 14, further comprising a storage vessel configured to receive material from a slag and condensate outlet system, wherein a centrifugal vortex-cooler separator is tangentially connected to the syngas outlet system to receive a tangential supersonic syngas jet.

16. A detonation steam superheater for thermal recycling of waste, the detonation steam superheater comprising:
a. a detonation chamber;
b. a fuel supply system configured to supply fuel for detonation in the detonation chamber;
c. an oxidizer supply system configured to supply oxidizer for detonation in the detonation chamber;
d. a feedwater supply system;
e. a detonation channel in communication with the detonation chamber;
f. a gas-dynamic resonator in communication with the detonation channel, wherein the detonation chamber is configured to support rotating detonation waves that generate a supersonic superheated steam jet; and
g. wherein the gas-dynamic resonator is configured to receive longitudinally pulsating detonation waves from the detonation channel and to subject the supersonic superheated steam jet to shock-resonant compression to produce a supersonic ultra-superheated steam jet.

17. The detonation steam superheater of claim 16, further comprising a receiver, one or more injectors fluidly coupled between the receiver and the detonation chamber.

18. The detonation steam superheater of claim 16, wherein the detonation chamber is an annular detonation chamber.

19. The detonation steam superheater of claim 16, wherein the detonation steam superheater further comprises an inner annular cavity and a plurality of hole-turbulators disposed in a wall of the annular detonation chamber.

20. The detonation steam superheater of claim 17, wherein the gas-dynamic resonator is a cooled conical gas-dynamic resonator aligned with the detonation channel and comprising a Laval nozzle defining an outer annular conical cavity.
